(19) United States
(12) Patent Application Publication
(10) Pub. No.: US 2013/0248751 A1
(43) Pub. Date: Sep. 26, 2013

(54) CONTROL VALVE SEAL ASSEMBLY ENERGIZED BY SHAPE MEMORY ALLOYS AND FLUID VALVES COMPRISING SAME

(71) Applicant: Shawn W. Anderson, Haverhill, IA (US)

(72) Inventor: Shawn W. Anderson, Haverhill, IA (US)

(73) Assignee: FISHER CONTROLS INTERNATIONAL LLC, Marshalltown, IA (US)

(21) Appl. No.: 13/429,893

(22) Filed: Mar. 26, 2012

(51) Int. Cl. F16K 1/42

(52) U.S. Cl. 251/359

(57) ABSTRACT

A fluid valve includes a valve body having a fluid inlet and a fluid outlet connected by a fluid passageway. A valve seat is disposed within the fluid passageway. A fluid control member is movably disposed within the fluid passageway, the fluid control member cooperating with the valve seat to control fluid flow through the fluid passageway. A seal assembly is disposed within the valve body, the seal assembly preventing fluid from leaking through the valve body when the fluid control member is in a closed position. The seal assembly is made, at least in part, from a shape-memory alloy.

### BACKGROUND

1. Field of the Disclosure

The invention generally relates to control valve seals and more specifically to control valve seals that are energized by, or comprise, shape memory alloys.

2. Related Technology

Fluid valves control the flow of fluid from one location to another. When the fluid valve is in a closed position, high pressure fluid on one side of the valve is prevented from flowing to a lower pressure location on the other side of the valve. Often fluid valves contain a movable fluid control member and a seat of some sort that cooperates with the fluid control member to control or stop fluid flow through the valve. While many different types of fluid valves exist, the general principle of physically separating a higher pressure fluid region from a lower pressure fluid region applies to all fluid valves. Because of this pressure difference, fluid from the high pressure side will naturally try to migrate to the lower pressure side by any means possible. Often space between the movable control member and a valve housing may provide an avenue by which higher pressure fluid can migrate (or leak) to the lower pressure region. In order to prevent leaks, most fluid valves include one or more seals between valve parts to prevent fluid leaks.

In less severe temperature environments, the seals of fluid valves may be made of relatively pliable materials such as elastomeric materials. Elastomeric seals are relatively easy to install due to their pliable nature. More particularly, elastomeric seals can be stretched or otherwise manipulated during installation. Because of this flexible nature, elastomeric seals also adapt to minor structural variations between valve parts. However, elastomeric seals are temperature limited to environments less than about 450° F. Above about 450° F., elastomeric materials begin to break down, which can lead to fluid leaks. Another drawback to elastomeric seals is that elastomeric seals tend to lose the ability to apply a load to another member at higher temperatures.

Seals in fluid valves used in high temperature environments are generally made from more robust materials, such as graphite. While graphite seals are relatively temperature tolerant for most high temperature operations, graphite seals are relatively rigid. This rigidity of graphite seals makes graphite seals more difficult to place in the valve during assembly. Additionally, once placed, graphite seals require a relatively constant load or pressure between valve parts, which may not be desirable in environments having large changes in operating temperature.

### SUMMARY OF THE DISCLOSURE

A fluid valve includes a valve body having a fluid inlet and a fluid outlet connected by a fluid passageway. A valve seat is disposed within the fluid passageway. A fluid control member is movably disposed within the fluid passageway, the fluid control member cooperating with the valve seat to control fluid flow through the fluid passageway. A seal is disposed within the valve body, the seal preventing fluid from leaking through the valve body when the fluid control member is in a closed position. The seal is made from a shape-memory alloy.

### BRIEF DESCRIPTION OF THE DRAWINGS

FIG. 1 is a cross-sectional view of a fluid control valve including a shape-memory alloy seal assembly;

FIG. 2 is a close up cross-sectional view of circle 2 in FIG. 1;

FIG. 3 is a close up cross-sectional view of circle 3 in FIG. 1;

FIG. 4 is a cross-sectional view of one embodiment of a seal in the seal assembly of FIG. 1;

FIG. 5 is a cross-sectional view of another embodiment of the seal in the seal assembly of FIG. 1;

FIG. 6 is an alternate embodiment of a seal assembly;

FIG. 7 is yet another alternate embodiment of a seal assembly.

### DETAILED DESCRIPTION

A seal assembly constructed in accordance with the disclosure advantageously has a relatively low stress at low temperatures and a higher stress at higher temperatures. The lower stress state facilitates assembly of a control valve, including installing the seal assembly, because the seal assembly is more pliable and manipulatable at low stress. The higher stress state, on the other hand, promotes better sealing at high temperatures. The higher stress state counteracts or offsets different thermal expansion rates of valve parts, and higher fluid pressures at higher temperatures. In some cases, the seal provides lower frictional forces for dynamic seals that move with a fluid control member. Additionally, the seal assembly is useful over a very large range of temperatures. For example, the seal assembly may be used in control valves experiencing temperatures from between 0° F. to over 1000° F. The seal assembly solves the problems of prior art seals discussed above by forming at least part of the seal assembly from a shape-memory alloy material,

Shape memory alloys have unique properties that permit them to undergo a solid state phase change when heated (e.g., from a deformed martensite phase to an austenite phase). When in an austenite phase, a ring-shaped seal assembly formed from shape-memory alloy material may have a diameter (or inner dimension) that is slightly smaller than an inner diameter of a valve part to facilitate assembly of the seal assembly into the fluid control valve. At a transition temperature, the ring-shaped seal assembly transforms into an austenitic phase, which causes the ring-shaped seal assembly to attempt to expand. This attempted expansion causes the ring-shaped seal assembly to press against certain valve components, thereby creating a stronger seal and/or compensating for different rates of thermal expansion between certain valve components.

Examples of a shape memory alloy materials that may be suitable for use in forming the seal assembly include Nickel Titanium, also known as NiTi or Nitinol (near-equiatomic titanium-nickel alloy). Other shape-memory and superelastic alloys, or high temperature shape-memory alloys, such as NiTi X alloys, wherein X is Hf or Zr substituted for Ti and/or X is Cu, Pd, Pt and/or Au substituted for Ni, e.g., NiTiCu or TiNiPd.

Shape-memory alloys, such as NiTi, exhibit two remarkable strain recovery properties in wrought form, i.e., the shape memory effect and superelasticity. The first property refers to an ability of an shape-memory alloy to recover from large mechanically induced strains (i.e., up to 8%, e.g., in extant shape-memory alloy structures) by moderate increases in temperature. The latter property refers to the rubber-like, hysteretic strain recovery in relatively high temperature regimes. In each case, the underlying mechanism is a reversible martensitic transformation between solid-state phases that can be induced by changes in temperature or stress. Some shape-memory alloys also have excellent structural properties and excellent corrosion resistance, which are particularly useful properties in fluid control valve components.

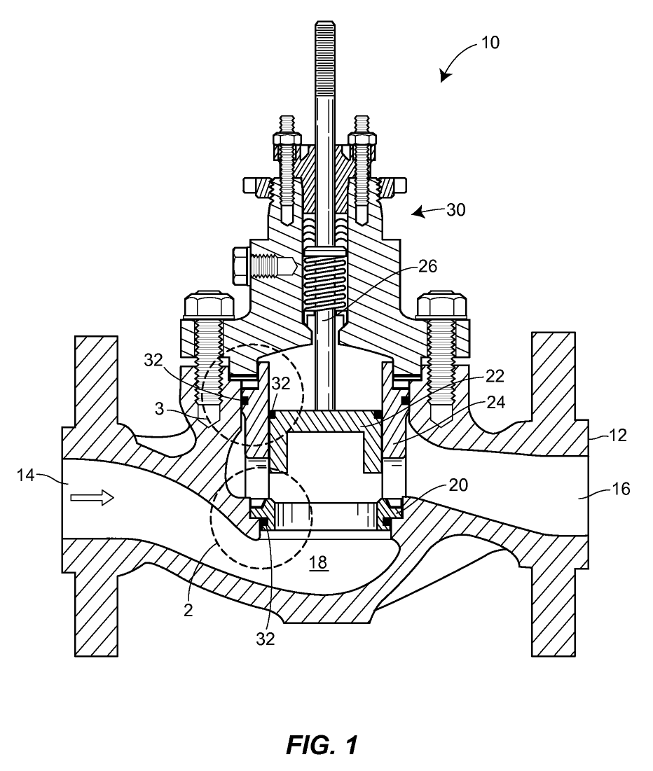

Turning now to FIG. 1, an exemplary fluid control valve 10 may include a valve body 12 having a fluid inlet 14 and a fluid outlet 16 connected by a fluid passageway 18. A valve seat 20 may be positioned within the fluid passageway 18. A fluid control member, such as a valve plug 22 may be slidably mounted within the valve body 12, the valve plug 22 interacting with the valve seat 20 to control fluid flow between the fluid inlet 14 and the fluid outlet 16. In this embodiment, a cage 24 may also be mounted within the valve body 12. The cage 24 acts as a guide for the valve plug 22 as the valve plug moves within the valve body 12. Additionally, the cage 24 may include a plurality of perforations or widows designed to characterize fluid flow through the fluid control valve 10. The valve plug 22 may be attached to a valve stem 26 that is moved by an actuator connected to a valve bonnet 30. The actuator operates the valve stem 26 in a reciprocating fashion to move the valve plug 22 towards, or away from, the valve seat 20 to control fluid flow through the valve body 12.

When the valve plug 22 is in a closed position, contacting the valve seat 20, to prevent fluid flow through the valve body 12, fluid pressure builds up on the inlet side of the valve body 12. As a result, fluid will attempt to flow from the high pressure inlet side to the low pressure outlet side by any means available. For example, fluid may attempt to flow through any gaps created between the valve seat 20 and the valve body 12, through any gaps between the cage 24 and the valve body 12, or through any gaps between the valve plug 22 and the cage 24. Other gaps may exist through which fluid may attempt to flow. One or more seal assemblies 32 may be placed in the gaps described above (or in any other gaps) to stop fluid flow through the gaps.

While a sliding stem valve is disclosed herein as an exemplary embodiment of a fluid control valve, the seal assemblies described herein may be used in virtually any type of fluid valve that includes a seal. For example, the disclosed seal assemblies may be used in various types of valves, e.g., ball valves, globe valves, butterfly valves, or eccentric plug valves.

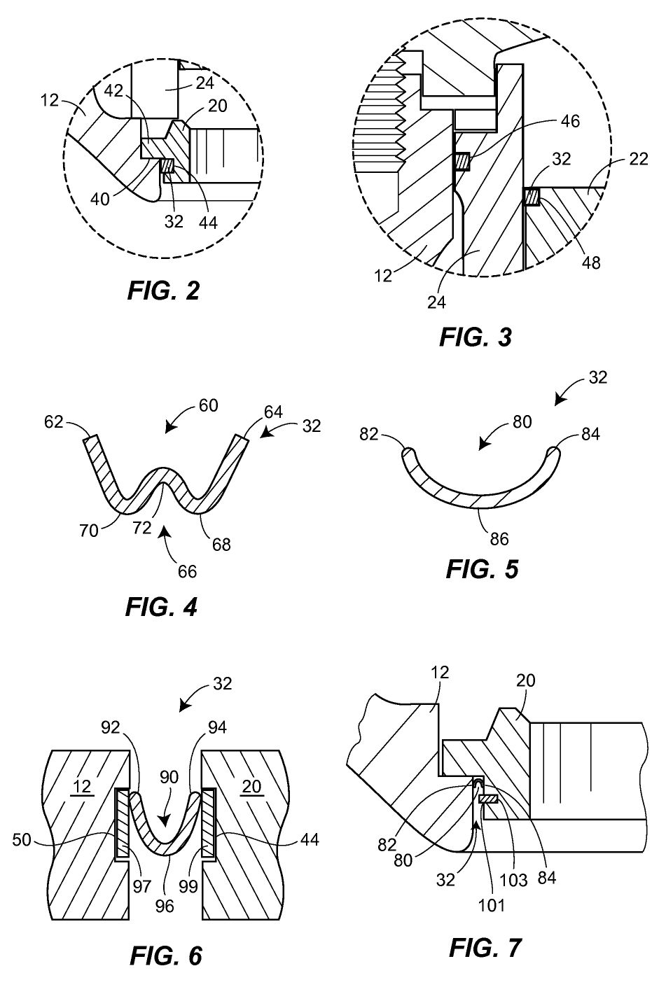

FIG. 2 is a close up of a portion of the seat ring 20 and the valve body 12. The valve body 12 may include a shoulder 40 sized and shaped to support an annular ledge 42 formed in an outer surface of the seat ring 20. In the embodiment of FIG. 2, an annular channel 44 may be formed in an outer surface of the seat ring 20, below the annular ledge 42, for receiving the seal assembly 32. In other embodiments, the seal assembly may be received in an annular channel formed in the valve body 12. In yet other embodiments, the seal assembly 32 may simply be located between an outer surface of the seat ring 20 and an inner surface of the valve body 12. Regardless, the seal assembly 32 prevents fluid from flowing between the seat ring 20 and the valve body 12.

FIG. 3 is a close up portion of the valve body 12, the cage 24, and the valve plug 22. FIG. 3 illustrates some alternate locations for the seal assembly 32. For example, the seal assembly 32 may be located in an annular channel 46 in the cage 24, to prevent fluid flow between the cage and the valve body 12. In other embodiments, the seal assembly 32 may be located in an annular channel formed in the valve body 12. Alternatively, the seal assembly 32 may be located in an annular channel 48 in the valve plug 22 to prevent fluid flow between the cage 24 and the valve plug 22. In other embodiments, the seal assembly 32 may be located in an annular channel formed in the cage 24. The seal assembly 32 locations illustrated in FIGS. 2 and 3 are only some examples of possible seal assembly locations. The disclosed seal assemblies may be located at virtually any location within the valve body 12.

FIG. 4 illustrates one embodiment of a seal assembly 32. In this embodiment, the seal assembly comprises a ring-shaped element made from a shape-memory alloy material. The seal assembly 32 has a w-shaped cross-section, comprising an opening 60 on one side. Two free ends 62, 64 may be connected by a convoluted portion 66 including a first convex portion 68 and a second convex portion 70 connected by a concave portion 72. The free ends 62, 64 may angle outwardly, away from one another so that when the shape-memory alloy material changes from a martinsitic phase to an austenitic phase increased material stress will be directed in an outward direction, causing the free ends 62, 64 to apply pressure to valve elements located on either side of the free ends 62, 64 (e.g., the valve body 12 and the valve seat 20 in FIG. 2). This increased stress will improve sealing capacity between the two valve elements.

FIG. 5 illustrates another embodiment of a seal assembly 32. The seal assembly 32 has a U-shaped cross-section including two free ends 82, 84 connected by a convex portion 86. An opening 80 may be formed in one side of the seal assembly 32. Similar to the embodiment of FIG. 4, when the shape-memory alloy material changes from a martinsitic phase to an austenitic phase, increased material stress will be directed in an outward direction, causing the free ends 82, 84 to apply pressure to valve components located on either side of the free ends 82, 84.

FIG. 6 illustrates yet another embodiment of a seal assembly 32. The seal assembly 32 in FIG. 6 may be used in environments where the use of graphite seal material is desirable. The seal assembly 32 has a U-shaped cross-sectional element including two free ends 92, 94 connected by a convex portion 96, similar to the embodiment of FIG. 5. An opening 90 may be formed between the two free ends 92, 94. A first graphite ring 97 may be located proximate the first free end 92 and a second graphite ring 99 may be located proximate the second free end 94. The first graphite ring 97 may be seated in an annular channel 50 formed in a first valve component, such as the valve body 12. The second graphite ring 99 may be seated in an annular channel 44 formed in a second valve component, such as the valve seat 20. In the embodiment of FIG. 6, the U-shaped element biases the first and second graphite rings 97, 99 outward to produce a tight seal between the valve body 12 and the valve seat 20.

FIG. 7 illustrates yet another embodiment of a seal assembly 32. The seal assembly 32 may include a U-shaped element made of a shape memory alloy material, similar to the seal assembly 32 of FIG. 5. The U-shaped element may be located between the valve seat 20 and the valve body 12. A seal retention mechanism, such as a spring clip 101, may be located upstream of the U-shaped element to restrain movement of the U-shaped element within the space between the valve seat 20 and the valve body 12. The spring clip 101 may be located at least partially within an annular channel 103 in the valve seat. Because the opening 80 of the U-shaped element is oriented towards inlet fluid flow, the fluid pressures the free ends 82, 84 outward, thus enhancing the fluid seal between the valve seat 20 and the valve body 12.

In each of the embodiments described above, the openings 60, 80, 90, may be oriented towards higher pressure fluid (i.e., towards the inlet in the direction of fluid flow) to further enhance sealing capacity by mechanically pressuring the free ends 62, 64, 82, 84, 92, 94 outward. This mechanical pressure may augment the increased material stress of the shape-memory alloy when changing from the martinsitic phase to the austenitic phase or the mechanical pressure may provide an increased sealing force before the shape-memory alloy material reaches the transition point.

The seal assemblies described herein provide increased sealing capacity at high temperatures. The seal assemblies also facilitate assembly of fluid control valves by being flexible at low temperatures. Other benefits include a more uniform geometry, which also simplifies the manufacturing process.

Although certain seal assemblies and fluid control valves have been described herein in accordance with the teachings of the present disclosure, the scope of the appended claims is not limited thereto. On the contrary, the claims cover all embodiments of the teachings of this disclosure that fairly fall within the scope of permissible equivalents.

1. A fluid valve comprising:
a valve body having a fluid inlet and a fluid outlet connected by a fluid passageway;
a valve seat disposed within the fluid passageway;
a fluid control member movably disposed within the fluid passageway, the fluid control member cooperating with the valve seat to control fluid flow through the fluid passageway; and
a seal assembly disposed within the valve body, the seal assembly preventing fluid from leaking through the valve body when the fluid control member is in a closed position,
wherein the seal assembly comprises a shape memory alloy.

2. The fluid valve of claim 1, wherein the seal assembly is disposed between the valve seat and the valve body.

3. The fluid valve of claim 2, wherein the seal assembly applies a load to the valve seat to enhance the sealing effect of the valve seat when the fluid control member is in a closed position.

4. The fluid control valve of claim 2, wherein the valve seat includes a ledge that rests on a shoulder formed in the valve body, a seal retention mechanism is located between the valve seat and the valve body, and the seal assembly is located between the seal retention mechanism and the ledge.

5. The fluid control valve of claim 4, wherein the seal retention mechanism is a spring clip.

6. The fluid valve of claim 1, wherein the seal assembly comprises a Nickel-Titanium alloy.

7. The fluid valve of claim 1, wherein the seal assembly comprises a Cobalt-Nickel-Aluminum alloy.

8. The fluid valve of claim 1, wherein the seal assembly comprises a U-shaped element having an opening directed towards high pressure fluid.

9. The fluid valve of claim 1, wherein the seal assembly comprises a w-shaped element having an opening directed towards high pressure fluid.

10. The fluid valve of claim 1, wherein the seal assembly is located between a first graphite layer and a second graphite layer.

11. The fluid valve of claim 10, wherein the first graphite layer is at least partially disposed within a first annular recess in the valve body.

12. The fluid valve of claim 11, wherein the second graphite layer is at least partially disposed within a second annular recess in the valve seat.

13. The fluid valve of claim 1, further comprising a cage within the valve body.

14. The fluid valve of claim 13, wherein the seal assembly is located between the cage and the valve body.

15. The fluid valve of claim 13, wherein the seal assembly is located between the cage and the fluid control member.

16. The fluid valve of claim 1, wherein the seal assembly is in a martensitic phase at lower temperatures and the seal is in a austenitic phase at higher temperatures.

17. The fluid valve of claim 16, wherein the seal assembly changes from the martensitic phase to the austenitic phase at a temperature of between about 400° F. and about 500° F.

18. The fluid valve of claim 16, wherein the seal assembly exhibits a lower spring rate in the martensitic phase and a higher spring rate in the austenitic phase.

19. The fluid valve of claim 1, wherein the valve seat is made of a material having a first thermal expansion coefficient and the valve body is made from a material having a second thermal expansion coefficient and the seal assembly is located between the valve seat and the valve body, the seal assembly changing from a martensitic phase to a austenitic phase and back to the martensitic phase to maintain a relatively constant load on the valve seat as the valve seat and valve body expand and contract as temperatures change.

20. A fluid valve seal comprising:
a first ring of graphite;
a second ring of graphite; and
a shape-memory alloy component disposed between the first ring of graphite and the second ring of graphite.

21. The fluid valve seal of claim 20, wherein the shape-memory alloy component is U-shaped.

22. The fluid valve seal of claim 20, wherein the shape-memory alloy is w-shaped.
